(19) United States
(12) Patent Application Publication
(10) Pub. No.: US 2026/0320960 A1
(43) Pub. Date: Oct. 15, 2026

(54) METHOD AND SYSTEM FOR CORRECTING SKEWNESS IN IMAGES

(71) Applicant: L&T TECHNOLOGY SERVICES LIMITED, Chennai (IN)

(72) Inventors: PAVAN NARASIMHA MURTHY, Mysuru (IN); PRAGYESH KUMAR, Agra (IN)

(21) Appl. No.: 19/324,229

(22) Filed: Sep. 10, 2025

(30) Foreign Application Priority Data
Apr. 15, 2025 (IN) 202541036399

(51) Int. Cl. G06V 10/24; G06V 10/25

(52) U.S. Cl. CPC G06V 10/243; G06V 10/242; G06V 10/25

(57) ABSTRACT

A method and system for correcting skewness in images is disclosed. A processor receives a skewed image comprising a schematic illustration. A set of horizontal lines are determined in the schematic illustration. For each of the set of horizontal lines, horizontal line contour is determined. A minimum area rectangle that encloses the horizontal line contour is determined. A first center coordinate, a first set of dimensions, and a first rotation angle of the horizontal line contour are determined. A set of corner coordinates of the horizontal line contour are determined. A second center coordinate is determined. A set of rotation angles is determined between the set of corner coordinates and the second center coordinate. A correction angle from the set of rotation angles is determined. A first bounding box having a second set of dimensions is determined. The skew-corrected image from the skewed image is determined.

### TECHNICAL FIELD

This disclosure relates generally to the field of image processing, and more particularly to a method and system for correcting skewness in images.

### BACKGROUND

Images that contain technical drawings, diagrams, or text, such as engineering blueprints or circuit layouts, are often scanned or captured using scanners or cameras. During this process, the images can become tilted or misaligned, which is commonly known as “skewness”. Skewed images make it difficult for people and computer systems to read the information correctly. For example, if a computer system is used to extract data from these skewed images, such as recognizing text or analyzing the layout, the skewness can lead to inaccurate results. Correcting this skewness is important to make sure the images are clear, properly aligned, and easy to interpret. Existing methods for correcting skewness in images may either crop important parts of the image, which cause loss of data, or they distort the alignment of the content within the image.

Therefore, there is a requirement for an efficient methodology of correcting skewness in images without losing important information or compromising the alignment of the content.

### SUMMARY OF THE INVENTION

In an embodiment, a method for correcting skewness in images is disclosed. The method may include receiving, by a processor, a skewed image comprising a schematic illustration. The method may further include determining, by the processor, a set of horizontal lines in the schematic illustration using a predefined function. The method may further include determining, by the processor and for each of the set of horizontal lines, a horizontal line contour using a thresholding function and a predefined thresholding range. The method may further include determining, by the processor and for each of the set of horizontal lines, a minimum area rectangle that encloses the horizontal line contour using a second predefined function. The method may further include determining, by the processor and for each of the set of horizontal lines, a first center coordinate, a first set of dimensions, and a first rotation angle of the horizontal line contour based on the minimum area rectangle. The method may further include determining, by the processor and for each of the set of horizontal lines, a set of corner coordinates of the horizontal line contour based on the determination of the first center coordinate, the first set of dimensions, and the first rotation angle. The method may further include determining, by the processor, a second center coordinate based on an average of the determined set of corner coordinates. The method may further include determining, by the processor, a set of rotation angles between the set of corner coordinates and the second center coordinate. The method may further include determining, by the processor, a correction angle from the set of rotation angles based on calculation of a mode of the set of rotation angles using a third predefined function. The method may further include determining, by the processor, a first bounding box having a second set of dimensions based on a third set of dimensions of the skewed image and a matrix of rotation using a fourth predefined function. In an embodiment, the first bounding box may be configured to enclose a skew-corrected image of the skewed image. In an embodiment, the matrix of rotation may be determined based on the correction angle and a third center coordinate of the skewed image. The method may further include determining, by the processor, the skew-corrected image from the skewed image by performing at least one of cropping the skewed image based on the first bounding box and the matrix of rotation, and padding the skewed image based on a fourth set of dimensions. In an embodiment, the fourth set of dimensions may be determined based on the matrix of rotation and a second bounding box. In an embodiment, the second bounding box may be determined based on the matrix of rotation.

In another embodiment, a system for correcting skewness in images is disclosed. The system may include a processor, and a memory communicably coupled to the processor, wherein the memory stores processor-executable instructions, which, when executed by the processor, cause the processor to receive a skewed image comprising a schematic illustration. The processor may further determine a set of horizontal lines in the schematic illustration using a first predefined function. The processor, for each of the set of horizontal lines, may further determine a horizontal line contour using a thresholding function and a predefined thresholding range. The processor, for each of the set of horizontal lines, may further determine a minimum area rectangle that encloses the horizontal line contour using a second predefined function. The processor, for each of the set of horizontal lines, may further determine a first center coordinate, a first set of dimensions, and a first rotation angle of the horizontal line contour based on the minimum area rectangle. The processor, for each of the set of horizontal lines, may further determine a set of corner coordinates of the horizontal line contour based on the determination of the first center coordinate, the first set of dimensions, and the first rotation angle. The processor may further determine a second center coordinate based on an average of the determined set of corner coordinates. The processor may further determine a set of rotation angles between the set of corner coordinates and the second center coordinate. The processor may further determine a correction angle from the set of rotation angles based on calculation of a mode of the set of rotation angles using a third predefined function. The process may further determine a first bounding box having a second set of dimensions based on a third set of dimensions of the skewed image and a matrix of rotation using a fourth predefined function. In an embodiment, the first bounding box may be configured to enclose a skew-corrected image of the skewed image. In an embodiment, the matrix of rotation may be determined based on the correction angle and a third center coordinate of the skewed image. The processor may further determine the skew-corrected image from the skewed image by performing at least one of cropping the skewed image based on the first bounding box and the matrix of rotation, and padding the skewed image based on a fourth set of dimensions. In an embodiment, the fourth set of dimensions may be determined based on the matrix of rotation and a second bounding box. In an embodiment, the second bounding box may be determined based on the matrix of rotation.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for correcting skewness in images, in accordance with an embodiment of the present disclosure.

FIG. 2 is a functional block diagram of various modules within a memory of a computing device of FIG. 1, configured to correct skewness in images, in accordance with an embodiment of the present disclosure.

FIG. 3 illustrates an exemplary skewed image, in accordance with an embodiment of the present disclosure.

FIG. 4 depicts an exemplary schematic diagram depicting determination of a set of corner coordinates of a horizontal line contour for each of a set of horizontal lines, in accordance with an embodiment of the present disclosure.

FIG. 5 illustrates an exemplary skew-corrected image determined by padding the skewed image of FIG. 3, in accordance with an embodiment of the present disclosure.

FIG. 6 illustrates an exemplary skew-corrected image determined by cropping the skewed image of FIG. 3, in accordance with an embodiment of the present disclosure.

FIGS. 7A and 7B illustrates a flowchart of a method of correcting skewness in images, in accordance with an embodiment of the present disclosure.

FIG. 8 illustrates a flowchart of a method of determining the skew-corrected image from the skewed image, in accordance with an embodiment of the present disclosure.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered as exemplary only, with the true scope being indicated by the following claims. Additional illustrative embodiments are listed.

Further, the phrases “in some embodiments”, “in accordance with some embodiments”, “in the embodiments shown”, “in other embodiments”, and the like, mean a particular feature, structure, or characteristic following the phrase is included in at least one embodiment of the present disclosure and may be included in more than one embodiment. In addition, such phrases do not necessarily refer to the same embodiments or different embodiments. It is intended that the following detailed description be considered exemplary only, with the true scope and spirit being indicated by the following claims.

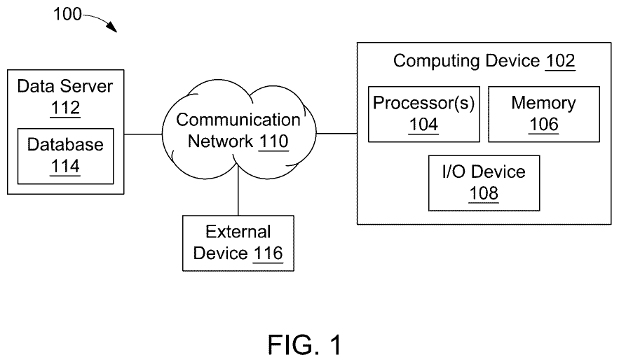

Referring now to FIG. 1, a block diagram of an exemplary system 100 for correcting skewness in images, is illustrated, in accordance with an embodiment of the present disclosure. The system 100 may include a computing device 102, a data server 112, and an external device 116 communicably coupled to each other through a wired or wireless communication network 110. The computing device 102 may include a processor 104, a memory 106, and an input/output (I/O) device 108.

In an embodiment, examples of processor(s) 104 may include, but are not limited to, microcontrollers, microprocessors, digital signal processors (DSPs), application-specific integrated circuits (ASICs), field-programmable gate arrays (FPGAs), system-on-chip (SoC) components, or any other suitable programmable logic devices. Examples of processor(s) 104 may include but are not limited to, an Intel® Itanium® or Itanium 2 processor(s), or AMD® Opteron® or Athlon MP® processor(s), Motorola® lines of processors, Nvidia®, FortiSOC™ system on a chip processors or other future processors.

In an embodiment, the memory 106 may store instructions that, when executed by the processor 104, and cause the processor 104 to correct the skewness in images, as will be discussed in greater detail herein below. In an embodiment, the memory 106 may be a non-volatile memory or a volatile memory. Examples of non-volatile memory may include but are not limited to, a flash memory, a Read Only Memory (ROM), a Programmable ROM (PROM), Erasable PROM (EPROM), and Electrically EPROM (EEPROM) memory. Further, examples of volatile memory may include but are not limited to, Dynamic Random Access Memory (DRAM), and Static Random-Access memory (SRAM).

In an embodiment, the I/O device 108 may comprise a variety of interface(s), for example, interfaces for data input and output devices, and the like. The I/O device 108 may facilitate inputting of images consisting of skewness, by a user communicating with the computing device 102. In an embodiment, the I/O device 108 may be wirelessly connected to the computing device 102 through wireless network interfaces such as Bluetooth®, infrared, or any other wireless radio communication known in the art. In an embodiment, the I/O device 108 may be connected to a communication pathway for one or more components of the computing device 102 to facilitate the transmission of inputted instructions and output results of data generated by various components such as, but not limited to, processor(s) 104 and memory 106.

In an embodiment, the data server 112 may be implemented as a remote cloud server or a co-located server and may include a database 114 to store a plurality of skewed images comprising schematic illustrations. The database 114 may further store skew-corrected images generated by the computing device 102, along with associated data necessary for the correction of skewness in images, including a set of horizontal lines, a set of corner coordinates, a first center coordinate, a second center coordinate, a first set of dimensions, a second set of dimensions, a set of rotation angles, a correction angle, a first bounding box, a second bounding box, and a matrix of rotation. In an embodiment, the database 114 may store data received from the external device 116, such as skewed images to be processed, as well as output generated by the computing device 102 such as the skew-corrected images. In an embodiment, the computing device 102 may be communicably coupled with the data server 112 through the communication network 110.

In an embodiment, the communication network 110 may be a wired or a wireless network or a combination thereof. The communication network 110 can be implemented as one of the different types of networks, such as but not limited to, ethernet IP network, intranet, local area network (LAN), wide area network (WAN), the internet, Wi-Fi, LTE network, CDMA network, 5G and the like. Further, the communication network 110 can either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the communication network 110 can include a variety of network devices, including routers, bridges, servers, computing devices, storage devices, and the like.

In an embodiment, the computing device 102 may receive a user input for correcting skewness in images from the external device 116 through the communication network 110. In an embodiment, the computing device 102 and the external device 116 may be a computing system, including but not limited to, a smart phone, a laptop computer, a desktop computer, a notebook, a workstation, a server, a portable computer, a handheld, or a mobile device. In an embodiment, the computing device 102 may be, but not limited to, in-built into the external device 116 or may be a standalone computing device.

In an embodiment, the computing device 102 may perform various processing in order to correct skewness in images. By way of an example, the computing device 102 may receive a skewed image as an input. In an embodiment, the skewed image may include a schematic illustration. In an embodiment, the schematic illustration may represent any form of technical or engineering drawing, including but not limited to, a piping and instrumentation diagram (P&ID), an electrical circuit diagram, a process flow diagram (PFD), a mechanical assembly drawing, a block diagram, a structural blueprint, or an architecture layout. Such schematic illustrations may comprise a plurality of graphical elements, including but not limited to, lines, symbols, labels, annotations, and text, which require precise alignment and orientation for accurate interpretation. It should be noted that the input may be indicated or provided by a user via the I/O device 108. For example, the user may indicate a file path corresponding to the location of the skewed image or may directly upload the skewed image to the computing device 102 through the I/O device 108.

The computing device 102 may then pre-process the received skewed image to determine an inverse grayscale image using a pre-processing technique. In an embodiment, the pre-processing may include converting the skewed image from its original color space, such as Red-Green-Blue (RGB) to a grayscale representation.

The computing device 102 may further determine a set of horizontal lines in the schematic illustration using a first predefined function. In an embodiment, the first predefined function may correspond to an image processing technique. In other words, the computing device 102 may determine the set of horizontal lines in the schematic illustration using the inverse grayscale image. In an embodiment, the first predefined function may include, but is not limited to, kernel-based line extraction function, morphological line extraction function, or a combination thereof. In an example implementation, the kernel-based line extraction function may utilize a specifically designed structuring element or kernel, such as a rectangular or linear kernel, oriented in the horizontal direction. Additionally, or alternatively, the morphological line extraction function may employ morphological operations such as erosion and dilation using a horizontal structuring element.

Further, the computing device 102, for each of the set of horizontal lines, may determine a horizontal line contour using a thresholding function and a predefined thresholding range. In an embodiment, the thresholding function may be implemented to convert the inverse grayscale image, or a portion thereof containing the horizontal lines, into a binary image. In an embodiment, the thresholding function may include, but is not limited to, a global thresholding function, an adaptive thresholding function, or an Otsu's thresholding function. In an embodiment, the thresholding range for the thresholding function may be (0, 255). In one example, the global thresholding function may apply a predefined thresholding range, wherein each pixel intensity in the inverse grayscale image is compared to a fixed threshold value. Pixels with intensity values greater than or equal to the threshold value may be assigned a maximum intensity value (typically 255), representing the foreground, while those below the threshold may be assigned the minimum intensity value (typically 0), representing the background. In the present embodiment, the predefined thresholding range may be between 0 and 255, with 0 representing the minimum intensity and 255 representing the maximum intensity in an 8-bit grayscale image.

The computing device 102, for each of the set of horizontal lines, may further determine a minimum area rectangle that may enclose the horizontal line contour using a second predefined function. In an embodiment, the second predefined function may correspond to an image processing technique. In an embodiment, the second predefined function may include, but is not limited to, a geometric boundary detection function or an equivalent algorithm configured to compute the minimum area rectangle around a given contour. Such a function may be implemented using any suitable image processing library or framework. In an exemplary implementation, the second predefined function may take as input the horizontal line contour previously extracted by the thresholding function. The horizontal line contour is typically represented as a list or an array of coordinate points that define the boundary of the detected horizontal line. Upon receiving this horizontal line contour, the second predefined function determines the minimum area rectangle that may completely enclose the horizontal line contour.

Furthermore, the computing device 102, for each of the set of horizontal lines, may determine a first center coordinate, a first set of dimensions, and a first rotation angle of the horizontal line contour based on the minimum area rectangle. In an embodiment, the first center coordinate may refer to the geometric center of the minimum area rectangle enclosing the horizontal line contour. The first center coordinate may be represented as a pair of values indicating the x and y coordinates of the geometric center in the two-dimensional plane of the minimum area rectangle. In an embodiment, the first set of dimensions may refer to the width of the minimum area rectangle that encloses the horizontal line contour. The width and height values correspond to the lengths of the sides of the minimum area rectangle along its principal axis. These dimensions are independent of axis of the skewed image and reflect the size of the horizontal line contour when bounded by the minimum area rectangle, which may be rotated relative to the axis of the skewed image. In an embodiment, the first rotation angle of the horizontal line contour may refer to the angular displacement of the minimum area rectangle relative to the horizontal axis of the skewed image. The first rotation angle may be typically measured in degrees and indicates the orientation of the horizontal line contour within the skewed image. A first rotation angle of zero degrees may indicate that the minimum area rectangle is perfectly aligned with the horizontal axis of the skewed image, while a non-zero angle signifies skewness.

Thereafter, the computing device 102, for each of the set of horizontal lines, may determine a set of corner coordinates of the horizontal line contour based on the determination of the first center coordinate, the first set of dimensions, and the first rotation angle. In an embodiment, the set of corner coordinates may correspond to the four vertices of the minimum area rectangle that encloses the horizontal line contour. In an embodiment, the set of corner coordinates may define the geometric boundary of the horizontal line contour. In an embodiment, the computing device 102 may determine the set of corner coordinates by utilizing a geometric transformation function, which converts the representation of the minimum area rectangle, defined by the first center coordinate, the first set of dimensions, and the first rotation angle into an array of four two-dimensional points. In an embodiment, this transformation may be implemented using any suitable image processing function capable of extracting vertex coordinates of a rotated rectangular boundary. Further, the computing device 102 may determine a second center coordinate based on an average of the determined set of corner coordinates.

In an embodiment, each of the set of coordinates represents a vertex of the minimum area rectangle in the coordinate space of the skewed image. However, the order in which these corner coordinates are returned by the geometric transformation function may not be consistent or aligned with a predefined order. To establish a consistency with the predefined order, the computing device 102 may determine the set of corner coordinates in the predefined order. The computing device 102, in order to determine the set of corner coordinates in the predefined order, may determine a set of left corner coordinates and a set of right corner coordinates of the horizontal line contour based on an angle cast by each of the set of corner coordinates with respect to the second center coordinate. In an embodiment, the predefined order may include bottom-left, top-left, top-right, and bottom-right. In an embodiment, the second center coordinate may be calculated as the average position of the set of corner coordinates of the minimum area rectangle.

In an exemplary implementation, to establish consistency with the predefined order for the set of corner coordinates, the computing device 102 may determine the set of corner coordinates in the predefined order based on their geometric relationship to the determined second center coordinate. The computing device 102 may implement a custom function, such as an “extreme points determination function”, which processes the set of corner coordinates. Initially, the computing device 102 may receive as input the set of corner coordinates of the minimum area rectangle. The set of corner coordinates may be determined using the geometric transformation function, which returns an unordered array of four coordinate points, each representing a vertex of the minimum area rectangle. The corner coordinates may be denoted as P1(x1, y1), P2(x2, y2), P3(x3, y3), and P4(x4, y4). The computing device 102 may calculate the second center coordinate, which represents the centroid of the minimum area rectangle. The second center coordinate may be computed by averaging the x-coordinates and y-coordinates of all four corner points.

Following the determination of the second center coordinate, the computing device 102 may calculate the angle between the second center coordinate and each of the set of corner coordinates. This may be achieved using a custom function, such as an “Angle_between_points” function, which computes the angle formed by the line connecting the second center coordinate to each of the set of coordinates.

Based on the cast angles, the computing device 102 may classify each corner coordinate as belonging to either the left side or the right side of the horizontal line contour. In one embodiment, corner points with angles between 90 degrees and 270 degrees may be classified as left corner coordinates, while the remaining corner points may be classified as right corner coordinates. Once the left and right groups are established, the computing device 102 may further differentiate between the top and bottom points within each group by comparing their y-coordinate values. Specifically, for the left corner coordinates, the point with the smaller y-coordinate may be designated as the top-left corner, and the point with the larger y-coordinate as the bottom-left corner. Similarly, for the right corner coordinates, the point with the smaller y-coordinate may be designated as the top-right corner, and the point with the larger y-coordinate as the bottom-right corner. In this manner, the computing device 102 may determine the set of corner coordinates consistent with the predefined order, including bottom-left, top-left, top-right, and bottom-right

Further, the computing device 102 may further determine a set of rotation angles between the set of corner coordinates and the second center coordinate. In an embodiment, the set of rotation angles may be normalized in a range of 0-360 degrees. In an embodiment, the set of rotation angles may represent angular displacement of each corner coordinate relative to the second center coordinate, which serves as reference point for the angular measurements. The set of rotation angles may be determined by the computing device 102 using a custom function, such as an “Angle_between_points” function, which may calculate the angle between two points (i.e., each corner coordinate and second center coordinate) in a two-dimensional coordinate space. In an exemplary embodiment, the computing device 102 may execute the “Angle_between_points” function by providing the second center coordinate as a starting point (reference point) and each corner coordinate of the set of corner coordinates as an endpoint. For each pair of points, the computing device 102 may calculate the angle formed by a line segment connecting the second center coordinate to the corresponding corner coordinate. The calculation may be performed using the custom function such as, but not limited to, an arctangent function, which may compute the angle in radians between the positive x-axis of the line segment connecting the two points.

Thereafter, the computing device 102 may determine a correction angle from the set of rotation angles based on calculation of a mode of the set of rotation angles using a third predefined function. In an embodiment, the third predefined function may correspond to an image processing technique. In an embodiment, the correction angle may represent a most frequently occurring angle among the set of rotation angles previously determined between each of the set of corner coordinates and the second center coordinate. The correction angle provides an estimation of the overall skewness or rotational misalignment present in the schematic illustration within the skewed image. In an exemplary implementation, the third predefined function may include, but is not limited to, a statistical mean or mode calculation function that analyses the distribution of the set of rotation angles and identifies the angle value that appears with the highest frequency. In one embodiment, the computing device 102 may utilize a statistical library or a custom-developed algorithm to compute the mode or mean. For example, the third predefined function used to perform the mode or mean calculation on the set of rotation angles may include statistical function from an open source scientific computation library, such as, but not limited to, “SciPy Python library”. The third predefined function may take as input an array or list of the set of rotation angles and returns an angle that occurs most frequently within the dataset. The resulting mode value corresponds to the correction angle. The correction angle may be represented as a negative or positive value depending on the direction of skewness detected in the schematic illustration. In some embodiments, the correction angle may be negated (multiplied by −1) to align with the image rotation convention used by the image processing library, such as OpenCV, which typically interprets positive angles as counterclockwise rotations.

The computing device 102 may further determine a first bounding box having a second set of dimensions based on a third set of dimensions of the skewed image and a matrix of rotation using a fourth predefined function. In an embodiment, the fourth predefined function may correspond to an image processing technique. In an embodiment, the first bounding box may be configured to enclose a skew-corrected image of the skewed image. In an embodiment, the matrix of rotation may be determined based on the correction angle and a third center coordinate of the skewed image. In an embodiment, the first bounding box may define a width and a height of an output canvas that will hold a skew-corrected image of the skewed image following rotation. In an embodiment, the fourth predefined function may include, but is not limited to, image rotation function and bounding box calculation function, such as a custom function referred to as “RotateToAngle”, which takes the skewed image, the correction angle, and a rotation handling type (for example, padding or cropping) as inputs and returns a skew-corrected image. In an embodiment, the third set of dimensions of the skewed image may refer to an original height and width of the skewed image prior to rotation. The third set of dimensions are typically obtained from the shape or size attributes of the skewed image, for example, through a call to the image attribute in any image processing library, with indexing [:2] to extract only the height and width while excluding any additional channels (such as color channels).

In an embodiment, the matrix of rotation, also known as the rotation matrix, may be determined based on the correction angle and the third center coordinate of the skewed image. In an embodiment, the matrix of rotation may be computed using a predefined image processing function configured to determine a two-dimensional affine transformation matrix. The inputs to this function may include the third center coordinate of the skewed image, which serves as the center point around which the rotation of the skewed image is performed. The correction angle, which specifies the degrees of rotation required to align the skewed image, and a scaling factor typically set to 1.0 to maintain the original size of the skewed image content. Once the rotation matrix is determined, the computing device 102 may compute the absolute values of the cosine component and sine component from the matrix of rotation to assess the effects of the rotation on the skew-corrected image. Using these cosine component and sine component, the computing device 102 may calculate the second set of dimensions of the first bounding box which represent the adjusted width and height necessary to fully encompass the skew-corrected image. The resulting first bounding box, defined by the second set of dimensions, may then be used to set the output canvas size and to adjust the translation terms within the matrix of rotation to ensure that the skew-corrected image is centered within the first bounding box.

Thereafter, the computing device 102 may determine the skew-corrected image from the skewed image by performing at least one of cropping the skewed image based on the first bounding box and the matrix of rotation, and padding the skewed image based on a fourth set of dimensions. In an embodiment, the fourth set of dimensions may be determined based on the matrix of rotation and a second bounding box. In an embodiment, the second bounding box may be determined based on the matrix of rotation. In an embodiment, the determination of whether to apply cropping or padding may be based on a user input or a predefined configuration parameter, typically passed to the computing device 102 as a rotation handling type, such as “ROTATION.CROP” or “ROTATION.PADDING”. In order to determine the skew-corrected image, the computing device 102 may determine a rotation direction based on the correction angle using a fifth predefined function. In an embodiment, the fifth predefined function may correspond to an image processing technique. The computing device 102, in order to determine the skew-corrected image, may determine a fourth center coordinate of the skew-corrected image based on the third center coordinate and the second set of dimensions.

In an embodiment, when cropping is selected, the computing device 102 may maintain original dimensions of the skewed image (i.e., the third set of dimensions of the skewed image), and apply the rotation transformation using the previously determined matrix of rotation. In this mode, no adjustment is made to the matrix of rotation beyond what is required to perform the affine transformation. The matrix of rotation may be directly applied to the skewed image using an affine transformation function. As a result, portions of the skew-corrected image that extend beyond the boundaries of the original dimensions (i.e., third set of dimensions of the skewed image) may be cropped out. Alternatively, when padding is selected, the computing device 102 may determine the fourth set of dimensions based on the matrix of rotation and a second bounding box. The fourth set of dimensions may represent the adjusted width and height necessary to fully encompass the skew-corrected image without cropping any part of its content. The fourth set of dimensions may be computed by extracting the absolute values of cosine and sine components of the matrix of rotation.

The second bounding box may be determined based on the matrix of rotation and may define the spatial region in which the skew-corrected image is fully enclosed. Once the second bounding box and fourth set of dimensions are determined, the computing device 102 may adjust the translation components of the matrix of rotation to ensure the skew-corrected image is properly centered within the new padded canvas (i.e., second bounding box).

This adjustment may ensure that the skew-corrected image is accurately aligned within the expanded bounding box and no content is clipped. In an embodiment, to determine the skew-corrected image, the computing device 102 may also determine a rotation direction based on the correction angle using a fifth predefined function. The fifth predefined function may correspond to an image processing technique that evaluates the correction angle and determines whether the rotation should be applied in a clockwise or counter-clockwise direction. For instance, in an OpenCV implementation, a positive rotation angle typically results in a counter-clockwise rotation, whereas a negative angle results in a clockwise rotation. In some cases, the correction angle may be subtracted from 360 degrees to align with the expected rotation convention of the image processing framework in use. Furthermore, in order to accurately position the skew-corrected image within the output canvas, the computing device 102 may determine a fourth center coordinate of the skew-corrected image. This fourth center coordinate may be calculated based on the third center coordinate of the skewed image and the second set of dimensions of the first bounding box. The fourth center coordinate may serve as the new reference point for aligning the skew-corrected image within the transformed coordinate space of the output canvas.

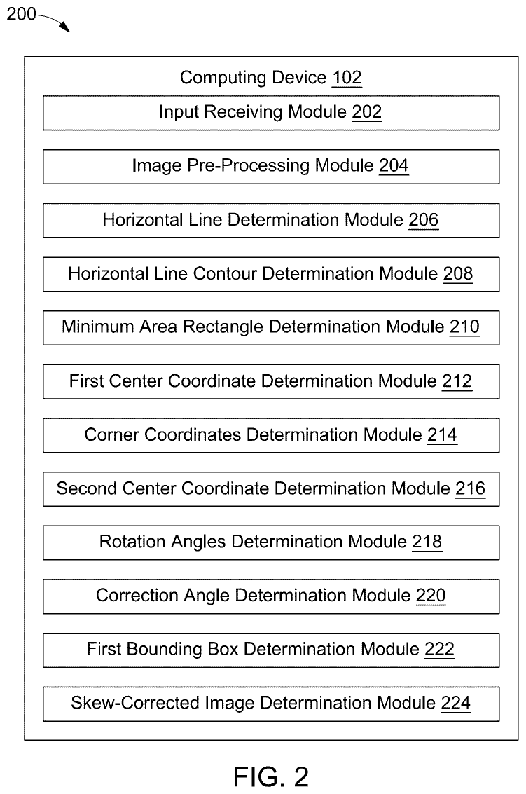

Referring now to FIG. 2, a functional block diagram 200 of various modules within the memory 106 of the computing device 102 of FIG. 1, configured to correct skewness in images, is illustrated, in accordance with an embodiment of the present disclosure. FIG. 2 is explained in conjunction with FIG. 1. The memory 106 may store an input receiving module 202, an image pre-processing module 204, a horizontal line determination module 206, a horizontal line contour determination module 208, a minimum area rectangle determination module 210, a first center coordinate determination module 212, a corner coordinates determination module 214, a second center coordinate determination module 216, a rotation angles determination module 218, a correction angle determination module 220, a first bounding box determination module 222, and a skew-correction image determination module 224.

The input receiving module 202 may receive a skewed image as an input. In an embodiment, the skewed image may include a schematic illustration. In an embodiment, the schematic illustration may represent any form of technical or engineering drawing, including but not limited to, a piping and instrumentation diagram (P&ID), an electrical circuit diagram, a process flow diagram (PFD), a mechanical assembly drawing, a block diagram, a structural blueprint, or an architecture layout. Such schematic illustrations may comprise a plurality of graphical elements, including lines, symbols, labels, annotations, and text, which require precise alignment and orientation for accurate interpretation. It should be noted that the input may be indicated or provided by a user via the I/O device 108. For example, the user may indicate a file path corresponding to the location of the skewed image or may directly upload the skewed image to the computing device 102 through the I/O device 108.

Further, the image pre-processing module 204 may pre-process the received skewed image to determine an inverse grayscale image using a pre-processing technique. In an embodiment, the pre-processing may include converting the skewed image from its original color space, such as Red-Green-Blue (RGB) to a grayscale representation.

Further, the horizontal line determination module 206 may determine a set of horizontal lines in the schematic illustration using a first predefined function. In an embodiment, the first predefined function may correspond to an image processing technique. In other words, the horizontal line determination module 206 may determine the set of horizontal lines in the schematic illustration using the inverse grayscale image. In an embodiment, the first predefined function may include, but is not limited to, kernel-based line extraction function, morphological line extraction function, or a combination thereof. In an example implementation, the kernel-based line extraction function may utilize a specifically designed structuring element or kernel, such as a rectangular or linear kernel, oriented in the horizontal direction. Additionally, or alternatively, the morphological line extraction function may employ morphological operations such as erosion and dilation using a horizontal structuring element. In one example, a morphological opening operation (erosion followed by dilation) may be performed on the inverse grayscale image with a horizontally elongated rectangular kernel.

Thereafter, the horizontal line contour determination module 208, for each of the set of horizontal lines, may determine a horizontal line contour using a thresholding function and a predefined thresholding range. In an embodiment, the thresholding function may be implemented to convert the inverse grayscale image, or a portion thereof containing the horizontal lines, into a binary image. In an embodiment, the thresholding function may include, but is not limited to, a global thresholding function, an adaptive thresholding function, or an Otsu's thresholding function. In an embodiment, the thresholding range for the thresholding function may be (0, 255). In one example, the global thresholding function may apply a predefined thresholding range, wherein each pixel intensity in the inverse grayscale image is compared to a fixed threshold value. Pixels with intensity values greater than or equal to the threshold value may be assigned a maximum intensity value (typically 255), representing the foreground, while those below the threshold may be assigned the minimum intensity value (typically 0), representing the background. In the present embodiment, the predefined thresholding range may be between 0 and 255, with 0 representing the minimum intensity and 255 representing the maximum intensity in an 8-bit grayscale image.

Further, the minimum area rectangle determination module 210, for each of the set of horizontal lines, may determine a minimum area rectangle that may enclose the horizontal line contour using a second predefined function. In an embodiment, the second predefined function may include, but is not limited to, a geometric boundary detection function or an equivalent algorithm designed to compute the minimum area rectangle around a given contour. Such a function may be implemented using any suitable image processing library or framework. In an exemplary implementation, the second predefined function may take as input the horizontal line contour previously extracted by the thresholding function. The horizontal line contour is typically represented as a list or an array of coordinate points that define the boundary of the detected horizontal line. Upon receiving this horizontal line contour, the second predefined function determines the minimum area rectangle that may completely enclose the horizontal line contour.

Furthermore, the first center coordinate determination module 212, for each of the set of horizontal lines, may determine a first center coordinate, a first set of dimensions, and a first rotation angle of the horizontal line contour based on the minimum area rectangle. In an embodiment, the first center coordinate may refer to the geometric center of the minimum area rectangle enclosing the horizontal line contour. The first center coordinate may be represented as a pair of values indicating the x and y coordinates of the geometric center in the two-dimensional plane of the minimum area rectangle. In an embodiment, the first set of dimensions may refer to the width of the minimum area rectangle that encloses the horizontal line contour. The width and height values correspond to the lengths of the sides of the minimum area rectangle along its principal axis. These dimensions are independent of axis of the skewed image and reflect the size of the horizontal line contour when bounded by the minimum area rectangle, which may be rotated relative to the axis of the skewed image. In an embodiment, the first rotation angle of the horizontal line contour may refer to the angular displacement of the minimum area rectangle relative to the horizontal axis of the skewed image. The first rotation angle may be typically measured in degrees and indicates the orientation of the horizontal line contour within the skewed image. A first rotation angle of zero degrees may indicate that the minimum area rectangle is perfectly aligned with the horizontal axis of the skewed image, while a non-zero angle signifies skewness.

Thereafter, the corner coordinates determination module 214, for each of the set of horizontal lines, may determine a set of corner coordinates of the horizontal line contour based on the determination of the first center coordinate, the first set of dimensions, and the first rotation angle. In an embodiment, the set of corner coordinates may correspond to four vertices of the minimum area rectangle that encloses the horizontal line contour. In an embodiment, the set of corner coordinates may define the geometric boundary of the horizontal line contour. In an embodiment, the corner coordinates determination module 214 may determine the set of corner coordinates by utilizing a geometric transformation function, which converts the representation of the minimum area rectangle, defined by the first center coordinate, the first set of dimensions, and the first rotation angle into an array of four two-dimensional points. In an embodiment, this transformation may be implemented using any suitable image processing function capable of extracting vertex coordinates of a rotated rectangular boundary. Further, the second center coordinate determination module 216 may determine a second center coordinate based on an average of the determined set of corner coordinates.

In an embodiment, each of the set of coordinates represents a vertex of the minimum area rectangle in the coordinate space of the skewed image. However, the order in which these corner coordinates are returned by the geometric transformation function may not be consistent or aligned with a predefined order. To establish a consistency with the predefined order, the corner coordinates determination module 214 may determine the set of corner coordinates in the predefined order. The corner coordinates determination module 214, in order to determine the set of corner coordinates in the predefined order, may determine a set of left corner coordinates and a set of right corner coordinates of the horizontal line contour based on an angle cast by each of the set of corner coordinates with respect to the second center coordinate. In an embodiment, the predefined order may include bottom-left, top-left, top-right, and bottom-right. In an embodiment, the second center coordinate may be calculated as the average position of the set of corner coordinates of the minimum area rectangle.

In an exemplary implementation, to establish consistency with the predefined order for the set of corner coordinates, the corner coordinates determination module 214 may determine the set of corner coordinates in the predefined order based on their geometric relationship to the determined second center coordinate. The corner coordinates determination module 214 may implement a custom function, such as an “extreme points determination function”, which processes the set of corner coordinates. Initially, the corner coordinates determination module 214 may receive as an input the set of corner coordinates of the minimum area rectangle. The set of corner coordinates may be determined using the geometric transformation function, which returns an unordered array of four coordinate points, each representing a vertex of the minimum area rectangle. The corner coordinates may be denoted as P1(x1, y1), P2(x2, y2), P3(x3, y3), and P4(x4, y4). The corner coordinates determination module 214 may calculate the second center coordinate, which represents the centroid of the minimum area rectangle. The second center coordinate may be computed by averaging the x-coordinates and y-coordinates of all four corner points. For example, the center x-coordinate (Cx) and center y-coordinate (Cy) may be calculated as follows:

“Cx=(x1+x2+x3+x4)/4”

“Cy=(y1+y2+y3+y4)/4”

In one instance, if the calculated center coordinate values are Cx=100 and Cy=200, the computing device 102 may apply a scaling factor of 0.25, resulting in adjusted center coordinates:

“Cx′=Cx×0.25=25”

“Cy′=Cy×0.25=50”

Following the determination of the second center coordinate, the corner coordinates determination module 214 may calculate the angle between the second center coordinate and each of the set of corner coordinates. This may be achieved using a custom function, such as an “Angle_between_points” function, which computes the angle formed by the line connecting the second center coordinate to each of the set of coordinates. The angle may be calculated using the arctangent function.

Based on the cast angles, the corner coordinates determination module 214 may classify each corner coordinate as belonging to either the left side or the right side of the horizontal line contour. In an embodiment, corner points with angles between 90 degrees and 270 degrees may be classified as left corner coordinates, while the remaining corner points may be classified as right corner coordinates. Once the left and right groups are established, the corner coordinates determination module 214 may further differentiate between the top and bottom points within each group by comparing their y-coordinate values. Specifically, for the left corner coordinates, the point with the smaller y-coordinate may be designated as top-left corner, and the point with the large y-coordinate as the bottom-left corner. Similarly, for the right corner coordinates, the point with the smaller y-coordinate may be designated as the top-right corner, and the point with the larger y-coordinate as the bottom-right corner. In this manner, the corner coordinates determination module 214 may determine the set of corner coordinates consistent with the predefined order, including bottom-left, top-left, top-right, and the bottom-right.

Thereafter, the rotation angles determination module 218 may determine a set of rotation angles between the set of corner coordinates and the second center coordinate. In an embodiment, the set of rotation angles may be normalized in a range of 0-360 degrees. In an embodiment, the set of rotation angles may represent angular displacement of each corner coordinate relative to the second center coordinate, which serves as reference point for the angular measurements. The set of rotation angles may be determined by the rotation angles determination module 218 using a custom function, such as an “Angle_between_points” function, which may calculate the angle between two points (i.e., each corner coordinate and second center coordinate) in a two-dimensional coordinate space. In an exemplary embodiment, the rotation angles determination module 218 may execute the “Angle_between_points” function by providing the second center coordinate as a starting point (reference point) and each corner coordinate of the set of corner coordinates as an endpoint. For each pair of points, the rotation angles determination module 218 may calculate the angle formed by a line segment connecting the second center coordinate to the corresponding corner coordinate. The calculation may be performed using the custom function such as, but not limited to, an arctangent function, which may compute the angle in radians between the positive x-axis of the line segment connecting the two points.

Thereafter, the correction angle determination module 220 may determine a correction angle from the set of rotation angles based on calculation of a mode of the set of rotation angles using a third predefined function. In an embodiment, the third predefined function may correspond to an image processing technique. In an embodiment, the correctio angle may represent a most frequently occurring angle among the set of rotation angles previously determined between each of the set of corner coordinates and the second center coordinate. The correction angle provides an estimation of the overall skewness or rotational misalignment present in the schematic illustration within the skewed image. In an exemplary embodiment, the third predefined function may include, but is not limited to, a statistical mode calculation function that analyses the distribution of the set of rotation angles and identifies the angle value that appears with the highest frequency. In one embodiment, the correction angle determination module 220 may utilize a statistical operation from open-source libraries or a custom-developed algorithm to compute the mode. Thus, based on input of an array of the set of rotation angles and an angle that occurs most frequently within the dataset may be determined. The resulting mode value corresponds to the correction angle. The correction angle may be represented as a negative or positive value depending on the direction of skewness detected in the schematic illustration. In some embodiments, the correction angle may be negated (multiplied by −1) to align with the image rotation convention used by the image processing library, such as, but not limited to, OpenCV, which typically interprets positive angles as counterclockwise rotations.

Further, the first bounding box determination module 222 may determine a first bounding box having a second set of dimensions based on a third set of dimensions of the skewed image and a matrix of rotation using a fourth predefined function. In an embodiment, the fourth predefined function may correspond to an image processing technique. In an embodiment, the first bounding box may be configured to enclose a skew-corrected image of the skewed image. In an embodiment, the matrix of rotation may be determined based on the correction angle and a third center coordinate of the skewed image. In an embodiment, the first bounding box may define a width and a height of an output canvas that will hold a skew-corrected image of the skewed image following rotation. In an embodiment, the fourth predefined function may include, but is not limited to, image rotation function and bounding box calculation function, such as a custom function referred to as “RotateToAngle”, which takes the skewed image, the correction angle, and a rotation handling type (for example, padding or cropping) as inputs and returns a skew-corrected image. In an embodiment, the third set of dimensions of the skewed image may refer to an original height and width of the skewed image prior to rotation. The third set of dimensions are typically obtained from the shape or size attributes of the skewed image, for example, through a call to the image attribute in any image processing library, with indexing [:2] to extract only the height and width while excluding any additional channels (such as color channels).

In an embodiment, the matrix of rotation, also known as the rotation matrix, may be determined based on the correction angle and the third center coordinate of the skewed image. In an embodiment, the matrix of rotation may be computed using a predefined image processing function configured to determine a two-dimensional affine transformation matrix. The inputs to this function may include the third center coordinate of the skewed image, which serves as the center point around which the rotation of the skewed image is performed. The correction angle, which specifies the degrees of rotation required to align the skewed image, and a scaling factor typically 1.0 to maintain the original size of the skewed image content. Once the rotation matrix is determined, the first bounding box determination module 222 may compute the absolute values of the cosine component and sine component from the matrix of rotation to assess the effects of the rotation on the skew-corrected image. Using these cosine component and sine component derived from the matrix of rotation, the first bounding box determination module 222 may calculate the second set of dimensions of the first bounding box which represents the adjusted width and height necessary to fully encompass the skew-corrected image. In an embodiment, these dimensions may be determined by applying a geometric transformation formula that accounts for the rotational displacement of the skewed image. The resulting first bounding box, defined by the second set of dimensions, may then be used to set the output canvas size and to adjust the translation terms within the matrix of rotation to ensure that the skew-corrected image is centered within the first bounding box.

Thereafter, the skew-corrected image determination module 224 may determine the skew-corrected image from the skewed image by performing at least one of cropping the skewed image based on the first bounding box and the matrix of rotation and padding the skewed image based on a fourth set of dimensions. In an embodiment, the fourth set of dimensions may be determined based on the matrix of rotation and a second bounding box. In an embodiment, the second bounding box may be determined based on the matrix of rotation. In an embodiment, the determination of whether to apply cropping or padding may be based on a use input or a predefined configuration parameter, typically passed to the skew-corrected image determination module 224 as a rotation handling type, such as “ROTATION.CROP” or “ROTATION.PADDING”. In order to determine the skew-corrected image, the skew-corrected image determination module 224 may determine a rotation direction based on the correction angle using a fifth predefined function. In an embodiment, each of the first predefined function, the second predefined function, the third predefined function, the fourth predefined function, and the fifth predefined function may correspond to an image processing technique. The skew-corrected image determination module 224, in order to determine the skew-corrected image, may determine a fourth center coordinate of the skew-corrected image based on the third center coordinate and the second set of dimensions.

In an embodiment, when cropping is selected, the skew-corrected image determination module 224 may maintain original dimensions of the skewed image (i.e., the third set of dimensions of the skewed image), and apply the rotation transformation using the previously determined matrix of rotation. In this mode, no adjustment is made to the matrix of rotation beyond what is required to perform the affine transformation. The matrix of rotation may be directly applied to the skewed image using an affine transformation function. As a result, portions of the skew-corrected image that extend beyond the boundaries of the original dimensions (i.e., third set of dimensions of the skewed image) may be cropped out. Alternatively, when padding is selected, the skew-corrected image determination module 224 may determine the fourth set of dimensions based on the matrix of rotation and a second bounding box. The fourth set of dimensions may represent the adjusted width and height necessary to fully encompass the skew-corrected image without cropping any part of its content. The fourth set of dimensions may be computed by extracting the absolute values of cosine and sine components of the matrix of rotation. Using these sine components and cos components, the skew-corrected image determination module 224 may calculate the width and height of the padded bounding box (i.e., the second bounding box).

The second bounding box may be determined based on the matrix of rotation and may define the spatial region in which the skew-corrected image is fully enclosed. Once the second bounding box and fourth set of dimensions are determined, the skew-corrected image determination module 224 may adjust the translation components of the matrix of rotation to ensure the skew-corrected image is properly centered within the new padded canvas (i.e., second bounding box). In an embodiment, the adjustment may include repositioning the center of the skewed image such that, upon rotation, the resulting skew-corrected image is centrally aligned within the second bounding box, which defines the padded output canvas. This may involve recalculating the translation components of the matrix of rotation so that the original center coordinate of the skewed image may be translated to coincide with the geometric center of the second bounding box. As a result, the skew-corrected image is properly centered within the transformed coordinate space of the skew-corrected image to ensure that no part of the corrected schematic illustration within the skew-corrected image is displaced or clipped during the rotation process.

This adjustment may ensure that the skew-corrected image is accurately aligned within the expanded bounding box and no content is clipped. In an embodiment, to determine the skew-corrected image, the skew-corrected image determination module 224 may also determine a rotation direction based on the correction angle using a fifth predefined function. The fifth predefined function may correspond to an image processing technique that evaluates the correction angle and determines whether the rotation should be applied in a clockwise or counter-clockwise direction. For instance, in an OpenCV implementation, a positive rotation angle typically results in a counter-clockwise rotation, whereas a negative angle results in a clockwise rotation. In some cases, the correction angle may be structured from 360 degrees to align with the expected rotation convention of the image processing framework in use. Furthermore, in order to accurately position the skew-corrected image within the output canvas, the skew-corrected image determination module 224 may determine a fourth center coordinate of the skew-corrected image. The fourth center coordinate may be calculated based on the third center coordinate of the skewed image and the second set of dimensions of the first bounding box. The fourth center coordinate may serve as the new reference point for aligning the skew-corrected image within the transformed coordinate space of the output canvas.

It should be noted that all such aforementioned modules 202-224 may be represented as a single module or a combination of different modules. Further, as will be appreciated by those skilled in the art, each of the modules 202-224 may reside, in whole or in parts, on one device or multiple devices in communication with each other. In some embodiments, each of the modules 202-224 may be implemented as dedicated hardware circuit comprising custom application-specific integrated circuit (ASIC) or gate arrays, off-the-shelf semiconductors such as logic chips, transistors, or other discrete components. Each of the modules 202-224 may also be implemented in a programmable hardware device such as a field programmable gate array (FPGA), programmable array logic, programmable logic device, and so forth. Alternatively, each of the modules 202-224 may be implemented in software for execution by various types of processors (e.g., processor 104). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for correcting skewness in images. For example, the exemplary system 100 and the associated computing device 102 may correct skewness in images by the processes discussed herein. In particular, as will be appreciated by those of ordinary skill in the art, control logic and/or automated routines for performing the techniques and steps described herein may be implemented by the system 100 and the associated computing device 102 either by hardware, software, or combinations of hardware and software. For example, suitable code may be accessed and executed by the one or more processors on the system 100 to perform some or all of the techniques described herein. Similarly, application specific integrated circuits (ASICs) configured to perform some, or all of the processes described herein may be included in the one or more processors on the system 100.

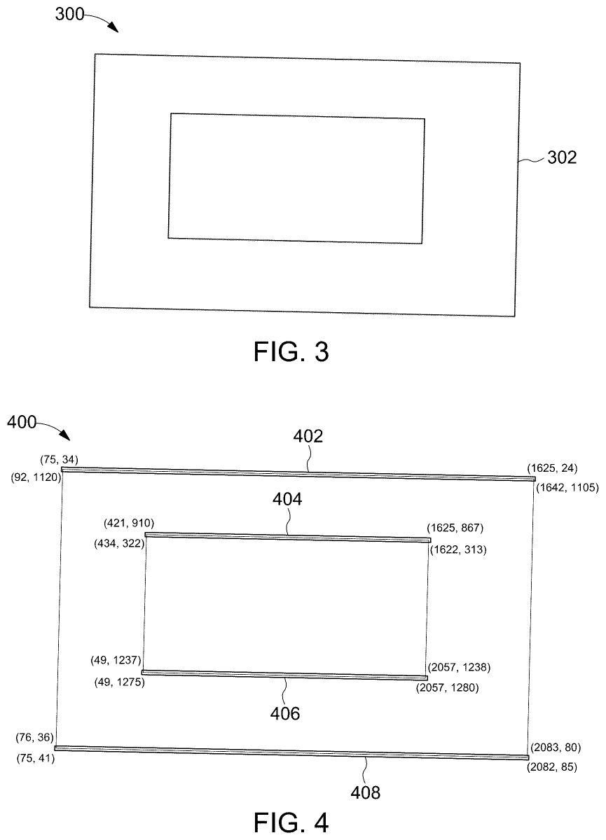

Referring now to FIG. 3, an exemplary skewed image 300, is illustrated, in accordance with an embodiment of the present disclosure. The skewed image 300 represents an input image that exhibits skewness or rotational misalignment, which may interfere with accurate interpretation or data extraction, particularly in image processing tasks such as optical character recognition (OCR) or schematic analysis.

The skewed image 300 may include a schematic illustration 302, which may represent any form of drawing such as, but not limited to, engineering drawing or technical drawing. Examples of such schematic illustrations may include, but are not limited to, a piping and instrumentation diagram (P&ID), an electrical circuit diagram, a process flow diagram (PFD), a mechanical assembly drawing, a block diagram, a structural blueprint, or an architectural layout. The schematic illustration 302 as shown in FIG. 3, may include graphical components such as an outer rectangle and an inner rectangle. As depicted in FIG. 3, the schematic illustration 302 appears rotated relative to its expected horizontal axis and vertical axis which indicates the presence of skewness in the skewed image 300. This skewness may have been introduced during image acquisition, scanning, or due to distortions inherent in the digital source. Such skew can result in misaligned graphical components and text which negatively impact downstream processing tasks, such as feature detection, data extraction, and classification. In accordance with the embodiment of the present disclosure, the skewed image 300 may serve as an input to the computing device 102 for correcting skewness in images, as described in the detailed description above.

Referring to FIG. 4, an exemplary schematic diagram 400 depicting determination of a set of corner coordinates of a horizontal line contour for each of a set of horizontal lines, is depicted, in accordance with an embodiment of the present disclosure. The schematic diagram 400 represents an example output generated by the computing device 102 during the skewness correction process, where a horizontal line contour for each of the set of horizontal lines is analysed to identity their respective bounding geometries. As illustrated in FIG. 4, the schematic diagram 400 may include a plurality of minimum area rectangles 402, 404, 406, 408 each enclosing a respective horizontal line contour detected within the skewed image 300 and may be determined using an image processing function (i.e., the second predefined function), such as a geometric boundary detection function, as described earlier in the present disclosure.

Each minimum area rectangle 402, 404, 406, 408 is defined by a set of corner coordinates, representing the four vertices of the corresponding minimum area rectangle. The set of corner coordinates may be determined by the computing device 102 based on the geometrical analysis of the horizontal line contours and may be typically calculated using a geometric transformation function, which converts the minimum area rectangle into four two-dimensional coordinate points.

In accordance with the illustrated embodiment, first minimum area rectangle 402 represents a first horizontal line contour and may be defined by its four respective corner coordinates, such as (75, 34). (1625, 24), (1642, 1105), (92, 1120). These points correspond to the vertices of the first minimum area rectangle 402 enclosing the outermost horizontal contour. Second minimum rectangle 404 represents a second horizontal line contour and may be defined by its corner coordinates, such as (421, 910), (1625, 867), (1622, 313), and (434, 322). These coordinates define the boundary of an inner horizontal line contour within the schematic illustration 302. Third minimum area rectangle 406 may represent a third horizontal line contour, with its corner coordinates determined as, (49, 1237), (2057, 1238), (2057, 1280), and (49, 1275). The third minimum area rectangle 408 may enclose another detected horizontal line within the schematic illustration 302. Fourth minimum area rectangle 408 may represent a fourth horizontal line contour, defined by its respective corner coordinates such as, (76, 36), (2083, 80), (2082, 85), (75, 41). The fourth minimum area rectangle 408 may enclose an additional horizontal line contour present in the schematic illustration 302. In an embodiment, the ordered arrangement of the corner coordinates for each minimum area rectangle 402, 404, 406, 408 may follow a predefined sequence, such as bottom-left, top-left, top-right, and bottom-right, as required for consistency in downstream processing.

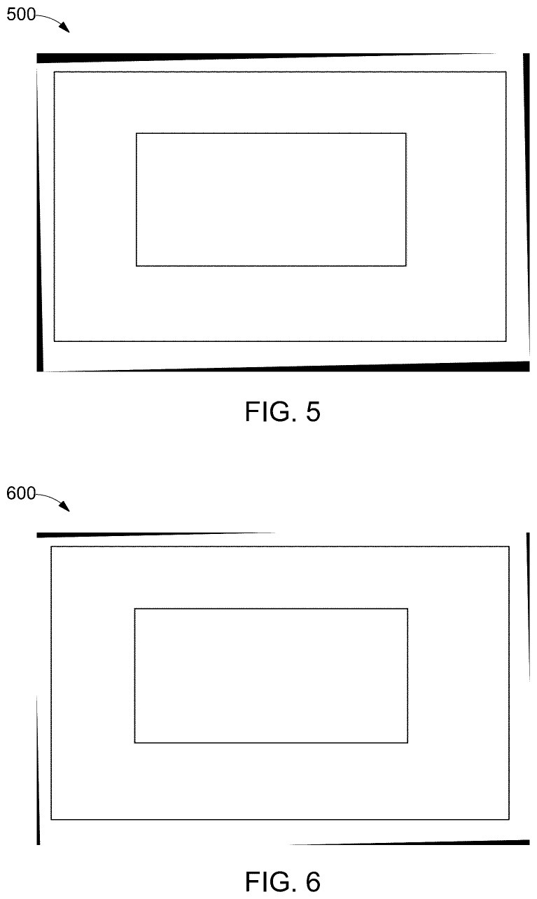

Referring now to FIG. 5, an exemplary skew-corrected image 500 determined by padding the skewed image 300 of FIG. 3, is illustrated, in accordance with an embodiment of the present disclosure. The skew-corrected image 500 depicts the result of applying the skewness correction process on the skewed image 300 as described above in FIG. 1 and FIG. 2, wherein the skewness correction has been achieved using a padding technique. As illustrated, the skew-corrected image 500 may include a rectified schematic illustration 302 that was originally misaligned due to skewness in the skewed image 300. In an embodiment, the padding technique may have been applied after rotating the skewed image 300 by a correction angle, thereby ensuring that no portion of the schematic illustration 302 was cropped during the rotation process. The correction angle may have been determined using a mode of the set of rotation angles computed between the set of corner coordinates of the minimum area rectangle 402, 404, 406, 408 enclosing the horizontal line contours, as described in the detailed description of FIG. 1 and FIG. 2.

In an embodiment, the skew-corrected image 500 is enclosed within a padded bounding box that fully contains the skew-corrected image 500. The padded regions are shown as black areas along the edges of the skew-corrected image 500, which results from the adjustment of the output canvas dimensions to accommodate the entire skew-corrected image 500 without any loss of data. These padded areas serve to preserve the integrity of the schematic illustration 300 to ensure that no graphical components are excluded from the final corrected image.

The padded bounding box (i.e., the second bounding box) may have been determined based on the matrix of rotation and the original dimensions (i.e., the third set of dimensions) of the skewed image 300, as calculated by the computing device 102. The translation components of the rotation matrix may have been adjusted to center the skew-corrected schematic illustration within the padded bounding box (i.e., second bounding box). In an embodiment, the skew-corrected image 500 provides a rectified version of the schematic illustration with proper alignment along its horizontal axis and vertical axis, suitable for further processing, interpretation, and data extraction.

Referring now to FIG. 6, an exemplary skew-corrected image 600 determined by cropping the skewed image 300 of FIG. 3, is illustrated, in accordance with an embodiment of the present disclosure. The skew-corrected image 600 depicts the result of applying a skewness correction process on the skewed image 300 as described above in FIG. 1 and FIG. 2, where the correction has been achieved using a cropping technique.

As illustrated in FIG. 6, the schematic illustration 302 within the skewed image 300 has been rotated by a correction angle to align the contents along the expected horizontal axis and vertical axis. Following the rotation, a cropping operation has been applied to remove any extra area outside the boundaries of the schematic illustration 302, resulting in the skew-corrected image 600. In an embodiment, the cropping technique may be applied after the rotation of the skewed image 300, using the first bounding box that defines the boundaries of the corrected schematic illustration. The first bounding box may be determined based on the matrix of rotation, the second set of dimensions derived from the skew-corrected image, and the correction angle computed earlier in the skewness correction process. As depicted, the skew-corrected image 600 includes clean, aligned horizontal and vertical edges corresponding to the corrected schematic illustration, while omitting the padded regions that would otherwise be included in the padding technique. In an embodiment, the skew-corrected image 600 has been generated by applying the matrix of rotation to the skewed image 300, followed by extracting the first bounding box, while maintaining the original aspect ratio of the schematic illustration 300. The final output shown in FIG. 6 presents an accurate, skew-corrected representation of the schematic illustration, suitable for further processing, analysis, or display.

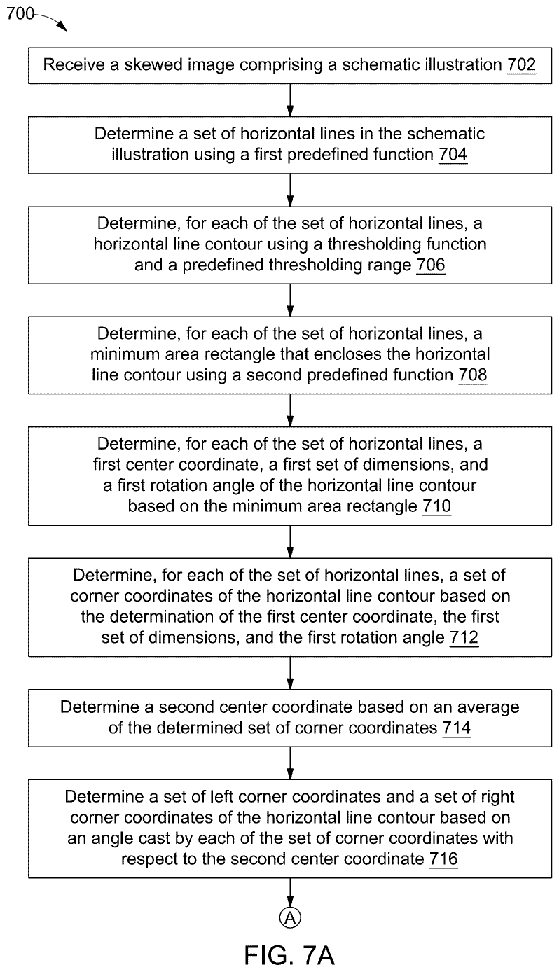

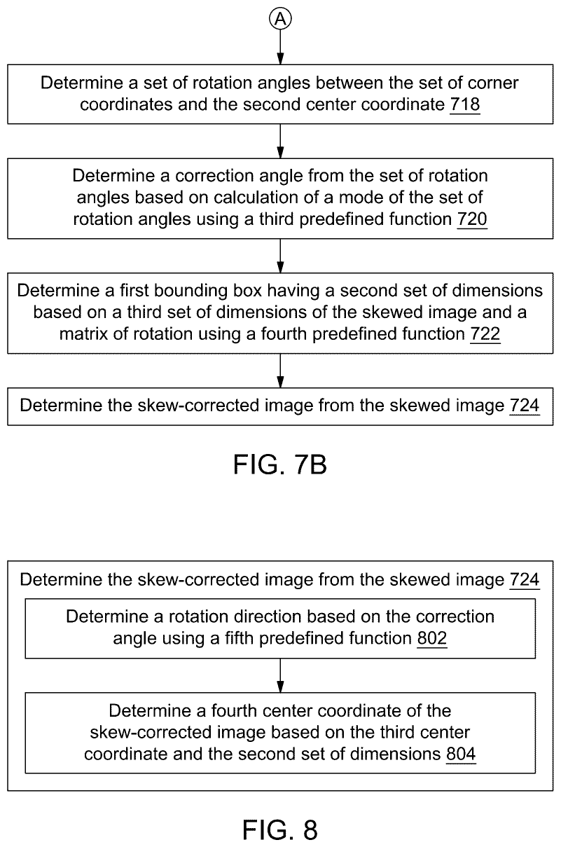

Referring now to FIGS. 7A and 7B, a flowchart 700 of a method of correcting skewness in images, is illustrated, in accordance with an embodiment of the present disclosure. FIGS. 7A and 7B are explained in conjunction with FIGS. 1 and 2. In an embodiment, the flowchart 700 may include a plurality of steps. Each step of the flowchart 700 may be executed by various modules, same as the modules of the computing device 102 so as to correct the skewness in images.

At step 702, a skewed image may be received as an input. In an embodiment, the skewed image may include a schematic illustration. It should be noted that the input may be indicated or provided by a user via the I/O device 108. For example, the user may indicate a file path or directly provide a skewed image. In an embodiment the received skewed image may be preprocessed to determine an inverse grayscale image.

Further at step 704, a set of horizontal lines may be determined in the schematic illustration using a first predefined function. In other words, the set of horizontal lines may be determined in the schematic illustration using the inverse grayscale image. In an embodiment, the first predefined function may include, but is not limited to, kernel operations and morphological operations.

Further at step 706, for each of the set of horizontal lines, a horizontal line contour may be determined using a thresholding function and a predefined thresholding range. Thereafter at step 708, for each of the set of horizontal lines, a minimum area rectangle may be determined that may enclose the horizontal line contour using a second predefined function. Further at step 710, for each of the set of horizontal lines, a first center coordinate, a first set of dimensions, and a first rotation angle of the horizontal line contour is determined based on the minimum area rectangle. Thereafter at step 712, for each of the set of horizontal lines, a set of corner coordinates of the horizontal line contour may be determined based on the determination of the first center coordinate, the first set of dimensions, and the first rotation angle. Further at step 714, a second center coordinate may be determined based on an average of the determined set of corner coordinates. In an embodiment, each of the set of coordinates represents a vertex of the minimum area rectangle in the coordinate space of the skewed image. However, the order in which these corner coordinates are determined may not be consistent or aligned with a predefined order. To establish a consistency with the predefined order, the set of corner coordinates may be determined in the predefined order.

In order to determine the set of corner coordinates in the predefined order, at step 716, a set of left corner coordinates and a set or right corner coordinates of the horizontal line contour may be determined based on an angle cast by each of the set of corner coordinates with respect to the second center coordinate. In an embodiment, the predefined order may include bottom-left, top-left, top-right, and bottom-right.

Further at step 718, a set of rotation angles may be determined between the set of corner coordinates and the second center coordinate. In an embodiment, the set of rotation angles may be normalized in a range of 0-360 degrees. Thereafter at step 720, a correction angle from the set of rotation angles may be determined based on calculation of a mode of the set of rotation angles using a third predefined function.

Further at step 722, a first bounding box having a second set of dimensions may be determined based on a third set of dimensions of the skewed image and a matrix of rotation using a fourth predefined function. In an embodiment, the first bounding box may be configured to enclose a skew-corrected image of the skewed image. In an embodiment, the matrix of rotation may be determined based on the correction angle and a third center coordinate of the skewed image.

Further at step 724, the skew-corrected image from the skewed image may be determined by performing at least one of cropping the skewed image based on the first bounding box and the matrix of rotation, and padding the skewed image based on a fourth set of dimensions. In an embodiment, the fourth set of dimensions may be determined based on the matrix of rotation and a second bounding box. In an embodiment, the second bounding box may be determined based on the matrix of rotation.

Referring now to FIG. 8, a flowchart of a method of determining the skew-corrected image from the skewed image, is illustrated, in accordance with an embodiment of the present disclosure. FIG. 8 is explained in conjunction with FIG. 7. In an embodiment, the flowchart may include a plurality of steps. Each step of the flowchart may be executed by various modules, same as the modules of the computing device 102 so as to determine the skew-corrected image from the skewed image.

At step 802, a rotation direction may be determined based on the correction angle using a fifth predefined function. In an embodiment, each of the first predefined function, the second predefined function, the third predefined function, the fourth predefined function, and the fifth predefined function may correspond to an image processing technique. Further at step 804, a fourth center coordinate of the skew-corrected image may be determined based on the third center coordinate and the second set of dimensions.

Thus, the disclosed method 700 and system 100 try to overcome the technical problem of correcting skewness in images by providing an accurate and efficient methodology for rectifying skewed schematic illustrations or technical drawings. The disclosed method 700 and system 100 utilizes image processing techniques, including, but not limited to, morphological operations, contour detection, minimum area rectangle determination, and rotation matrix computation, to accurately identify the skew characteristics of an input image. The disclosed method 700 and system 100 determines correction angle based on statistical analysis of rotation angles between identified corner coordinates and computes a matrix of rotation that aligns the schematic illustration along predefined axis.

In an embodiment, advantages of the disclosed method 700 and system 100 may include but are not limited to enhanced accuracy in preserving data and information of the image while correcting skewness of the image, improved efficiency through applying the padding option and creating a new bounding box for the skew-corrected image, and the like. As will be appreciated by those skilled in the art, the techniques described in the various embodiments discussed above are not routine, or conventional, or well-understood in the art. The techniques discussed above provide for correcting skewness in images.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps bring an improvement in the functioning of the device itself as the claimed steps provide a technical solution to a technical problem.

The specification has described a method 700 and system 100 for correcting skewness in images. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A method for correcting skewness in images, the method comprising:
receiving, by a processor, a skewed image comprising a schematic illustration;
determining, by the processor, a set of horizontal lines in the schematic illustration using a first predefined function;
for each of the set of horizontal lines:
determining, by the processor, a horizontal line contour using a thresholding function and a predefined thresholding range;
determining, by the processor, a minimum area rectangle that encloses the horizontal line contour using a second predefined function;
determining, by the processor, a first center coordinate, a first set of dimensions, and a first rotation angle of the horizontal line contour based on the minimum area rectangle; and
determining, by the processor, a set of corner coordinates of the horizontal line contour based on the determination of the first center coordinate, the first set of dimensions, and the first rotation angle;
determining, by the processor, a second center coordinate based on an average of the determined set of corner coordinates;
determining, by the processor, a set of rotation angles between the set of corner coordinates and the second center coordinate;
determining, by the processor, a correction angle from the set of rotation angles based on calculation of a mode of the set of rotation angles using a third predefined function;
determining, by the processor, a first bounding box having a second set of dimensions based on a third set of dimensions of the skewed image and a matrix of rotation using a fourth predefined function,
wherein the first bounding box is configured to enclose a skew-corrected image of the skewed image, and
wherein the matrix of rotation is determined based on the correction angle and a third center coordinate of the skewed image; and
determining, by the processor, the skew-corrected image from the skewed image by performing at least one of:
cropping, by the processor, the skewed image based on the first bounding box and the matrix of rotation; and
padding, by the processor, the skewed image based on a fourth set of dimensions,
wherein the fourth set of dimensions is determined based on the matrix of rotation and a second bounding box, and
wherein the second bounding box is determined based on the matrix of rotation.

2. The method of claim 1, wherein the received skewed image is preprocessed to determine an inverse grayscale image.

3. The method of claim 1, wherein the set of corner coordinates are determined in a predefined order, and
wherein the determination of the set of corner coordinates in the predefined order comprises:
determining, by the processor, a set of left corner coordinates and a set of right corner coordinates of the horizontal line contour based on an angle cast by each of the set of corner coordinates with respect to the second center coordinate,
wherein the predefined order comprising: bottom-left, top-left, top-right, and bottom-right.

4. The method of claim 1, wherein the set of rotation angles are normalized in a range of 0-360 degrees.

5. The method of claim 1, wherein the determination of the skew-corrected image comprises:
determining, by the processor, a rotation direction based on the correction angle using a fifth predefined function; and
determining, by the processor, a fourth center coordinate of the skew-corrected image based on the third center coordinate and the second set of dimensions.

6. The method of claim 5, wherein each of the first predefined function, the second predefined function, the third predefined function, the fourth predefined function and the fifth predefined function correspond to an image processing technique.

7. A system for correcting skewness in images, the system comprising:
a processor; and
a memory communicably coupled to the processor, wherein the memory stores processor-executable instructions, which, when executed by the processor, cause the processor to:
receive a skewed image comprising a schematic illustration;
determine a set of horizontal lines in the schematic illustration using a first predefined function;
for each of the set of horizontal lines:
determine a horizontal line contour using a thresholding function and a predefined thresholding range;
determine a minimum area rectangle that encloses the horizontal line contour using a second predefined function;
determine a first center coordinate, a first set of dimensions, and a first rotation angle of the horizontal line contour based on the minimum area rectangle; and
determine a set of corner coordinates of the horizontal line contour based on the determination of the first center coordinate, the first set of dimensions, and the first rotation angle;
determine a second center coordinate based on an average of the determined set of corner coordinates;
determine a set of rotation angles between the set of corner coordinates and the second center coordinate;
determine a correction angle from the set of rotation angles based on calculation of a mode of the set of rotation angles using a third predefined function;
determine a first bounding box having a second set of dimensions based on a third set of dimensions of the skewed image and a matrix of rotation using a fourth predefined function;
wherein the first bounding box is configured to enclose a skew-corrected image of the skewed image, and
wherein the matrix of rotation is determined based on the correction angle and a third center coordinate of the skewed image; and
determine the skew-corrected image from the skewed image by performing at least one of:
cropping the skewed image based on the first bounding box and the matrix of rotation; and
padding the skewed image based on a fourth set of dimensions,
wherein the fourth set of dimensions is determined based on the matrix of rotation and a second bounding box, and
wherein the second bounding box is determined based on the matrix of rotation.

8. The system of claim 7, wherein the received skewed image is preprocessed to determine an inverse grayscale image.

9. The system of claim 7, wherein the set of corner coordinates are determined in a predefined order,
wherein to determine the set of corner coordinates in the predefined order, the processor-executable instructions, when executed by the processor, cause the processor to:
determine a set of left corner coordinates and a set of right corner coordinates of the horizontal line contour based on an angle cast by each of the set of corner coordinates with respect to the second center coordinate,
wherein the predefined order comprising: bottom-left, top-left, top-right, and bottom-right.

10. The system of claim 7, wherein the set of rotation angles are normalized in a range of 0-360 degrees.

11. The system of claim 7, wherein to determine the skew-corrected image, the processor-executable instructions, which, when executed by the processor, cause the processor to:
determine a rotation direction based on the correction angle using a fifth predefined function; and
determine a fourth center coordinate of the skew-corrected image based on the third center coordinate and the second set of dimensions.

12. The system of claim 11, wherein each of the first predefined function, the second predefined function, the third predefined function, the fourth predefined function and the fifth predefined function correspond to an image processing technique.

13. A non-transitory computer-readable medium storing computer-executable instructions for correcting skewness in images, the computer-executable instructions configured for:
receiving a skewed image comprising a schematic illustration;
determining a set of horizontal lines in the schematic illustration using a first predefined function;
for each of the set of horizontal lines:
determining a horizontal line contour using a thresholding function and a predefined thresholding range;
determining a minimum area rectangle that encloses the horizontal line contour using a second predefined function;
determining a first center coordinate, a first set of dimensions, and a first rotation angle of the horizontal line contour based on the minimum area rectangle; and
determining a set of corner coordinates of the horizontal line contour based on the determination of the first center coordinate, the first set of dimensions, and the first rotation angle;
determining a second center coordinate based on an average of the determined set of corner coordinates;
determining a set of rotation angles between the set of corner coordinates and the second center coordinate;
determining a correction angle from the set of rotation angles based on calculation of a mode of the set of rotation angles using a third predefined function;
determining a first bounding box having a second set of dimensions based on a third set of dimensions of the skewed image and a matrix of rotation using a fourth predefined function,
wherein the first bounding box is configured to enclose a skew-corrected image of the skewed image, and
wherein the matrix of rotation is determined based on the correction angle and a third center coordinate of the skewed image; and
determining the skew-corrected image from the skewed image by performing at least one of:
cropping the skewed image based on the first bounding box and the matrix of rotation; and
padding the skewed image based on a fourth set of dimensions,
wherein the fourth set of dimensions is determined based on the matrix of rotation and a second bounding box, and
wherein the second bounding box is determined based on the matrix of rotation.

14. The non-transitory computer-readable medium of claim 13, wherein the received skewed image is preprocessed to determine an inverse grayscale image.

15. The non-transitory computer-readable medium of claim 13, wherein the set of corner coordinates are determined in a predefined order, and
wherein the determination of the set of corner coordinates in the predefined order comprises:
determining a set of left corner coordinates and a set of right corner coordinates of the horizontal line contour based on an angle cast by each of the set of corner coordinates with respect to the second center coordinate,
wherein the predefined order comprising: bottom-left, top-left, top-right, and bottom-right.

16. The non-transitory computer-readable medium of claim 13, wherein the set of rotation angles are normalized in a range of 0-360 degrees.

17. The non-transitory computer-readable medium of claim 13, wherein the the computer-executable instructions for the determination of the skew-corrected image are further configured for:
determining a rotation direction based on the correction angle using a fifth predefined function; and
determining a fourth center coordinate of the skew-corrected image based on the third center coordinate and the second set of dimensions.

18. The non-transitory computer-readable medium of claim 17, wherein each of the first predefined function, the second predefined function, the third predefined function, the fourth predefined function and the fifth predefined function correspond to an image processing technique.
